(19) United States
(12) Patent Application Publication
(10) Pub. No.: US 2016/0042066 A1
(43) Pub. Date: Feb. 11, 2016

(54) SEARCH RESULT PRECISION TOOL

(71) Applicant: Go Daddy Operating Company, LLC, Scottsdale, AZ (US)

(72) Inventors: Edward J. Karcher, III, Chandler, AZ (US); Brian James Dunn, Phoenix, AZ (US); Daniel K. Hardy, Phoenix, AZ (US)

(21) Appl. No.: 14/454,613

(22) Filed: Aug. 7, 2014

(51) Int. Cl. G06F 17/30; G06F 3/0484

(52) U.S. Cl. CPC G06F 17/30864; G06F 3/04847

(57) ABSTRACT

Example methods are disclosed for a search engine to produce a list of links to websites and for a domain name registrar to produce a plurality of domain names for a user. The list of links to websites and the plurality of domain names are preferably based on a search string and a desired relevance. A high desired relevance leads to exact or very close matches while a low desired relevance leads to indirect or exploratory matches when comparing the search string with the list of links to websites or the plurality of domain names. A webpage having a search string entry field and a relevance slider interface may be displayed to the user permitting the search engine or the domain name registrar to receive the search string and the desired relevance from the user. The search engine or domain name registrar may then determine and display to the user the list of links to the websites or the plurality of available domain names based on the search string and the desired relevance.

### FIELD OF THE INVENTION

The present invention generally relates to the field of producing a search result (which may be, as non-limiting examples, a list of links to websites or a plurality of domain names) based on a user input search string and a desired relevance of the search result with the search string.

### SUMMARY OF THE INVENTION

The present invention provides methods for determining and displaying search results given a search string and a desired relevance of the search string with the search results from a user. A first search engine webpage, comprising a search string entry field and a relevance slider interface, may be displayed to the user. The user may enter the search string in the search string entry field and select the desired relevance from the relevance slider interface. In a preferred embodiment, the search string is parsed to find one or more words or tokens in the search string.

One or more servers may determine a search result based on the search string and the desired relevance of the search string to the search result. A second search engine webpage that includes the search result may then be displayed to the user. The user may view the second search engine webpage and possibly interact with the search results. As a non-limiting example, the search results may be links to websites or webpages that the user may select to allow the user's browser to access those websites or webpages.

In some embodiments, the desired relevance comprises a location on a scale. The scale may range from a high relevance to a low relevance. The high relevance for the desired relevance preferably leads to a closely matching search result (or closely matching plurality of domain names) when compared to the search string while the low relevance for the desired relevance leads to a remotely relevant search result (or remotely relevant plurality of domain names) when compared to the search string. In preferred embodiments, the relevance slider interface may further comprise one or more intermediate desired relevancies (between the high relevance and the low relevance) locations that may also be selected by the user.

In some embodiments, the user may alter or change one or more times the desired relevance using the relevance slider interface. This process may be repeated each time the user changes the desired relevance and would cause a second desired relevance to be received from the user from the relevance slider interface. The one or more servers may determine a second search result (updated search result) based on the search string (which may also be changed one or more times by the user as desired) and the second desired relevance. The second search result (updated search result) may then be displayed to the user on a third search engine webpage. As with the second search engine webpage, the user may interact with the search result as desired.

In other embodiments, the present invention provides methods for determining and displaying a plurality of domain names given a search string and a desired relevance from the user. A first domain name spinning webpage, comprising a search string entry field and a relevance slider interface, may be displayed to the user. The user may enter the search string in the search string entry field and select the desired relevance from the relevance slider interface. In a preferred embodiment, the search string is parsed to find one or more words or tokens in the search string.

One or more servers may determine a plurality of domain names based on the search string and the desired relevance of the search string to the plurality of domain names. A second domain name spinning webpage, that includes the plurality of domain names, may then be displayed to the user. In some embodiments, the plurality of domain names may be checked for availability and only available domain names in the plurality of domain names are displayed to the user. The user may also be allowed to select and register one or more of the available domain names from the second domain name spinning webpage. A domain name registrar may register the selected domain names to the user.

In some embodiments, the user may alter or change one or more times the desired relevance using the relevance slider interface. This process may be repeated each time the user changes the desired relevance and would cause a second desired relevance to be received from the user from the relevance slider interface. The one or more servers may determine a second plurality of domain names (updated domain names) based on the search string (which may also be changed one or more times by the user as desired) and the second desired relevance. The second plurality of domain names (updated domain names) may then be displayed to the user on a third domain name spinning webpage. The user may be allowed to select and register one or more of the available domain names from the third domain name spinning webpage. A domain name register may register the selected domain names to the user.

The above features and advantages of the present invention will be better understood from the following detailed description taken in conjunction with the accompanying drawings.

### BRIEF DESCRIPTION OF THE DRAWINGS

FIG. 1 is a block diagram of a search engine illustrating a first search engine webpage at the start of an embodiment for a method of practicing the present invention.

FIG. 2 is a block diagram of the search engine illustrating a second search engine webpage after a user entered a search string in the search string entry field and the user selected a desired relevance from a desired relevance interface.

FIG. 3 is a block diagram of the search engine illustrating a third search engine webpage after the user changed or altered the desired relevance on the desired relevance interface.

FIG. 4 is a block diagram of a domain name registrar illustrating a first domain name spinning webpage at the start of an embodiment for a method of practicing the present invention.

FIG. 5 is a block diagram of the domain name registrar illustrating a second domain name spinning webpage after a user entered a search string in the search string entry field and selected a desired relevance from a desired relevance interface.

FIG. 6 is a block diagram of the domain name registrar illustrating a third domain name spinning webpage after the user changed or altered the desired relevance on the desired relevance interface.

FIG. 7 is a flow diagram illustrating a possible embodiment for determining search results after receiving a search string and a desired relevance from the user.

FIG. 8 is a flow diagram of FIG. 7 that also includes parsing the search string into one or more words or tokens from one or more languages.

FIG. 9 is a flow diagram of FIG. 7 that also includes additional steps that may occur if/when the user changes the desired relevance on the desired relevance interface.

FIG. 10 is a flow diagram illustrating a possible embodiment for displaying a plurality of domain names after receiving a search string and a desired relevance from the user.

FIG. 11 is a flow diagram of FIG. 10 that also includes parsing the search string into one or more words.

FIG. 12 is a flow diagram of FIG. 10 that also includes additional steps that may occur if/when the user changes the desired relevance on the desired relevance interface.

FIG. 13 is a flow diagram that illustrates a process for determining a search result based on a search string and a desired relevance that may be repeated every time a new search string is entered in the search string entry field by the user and/or the desired relevance on the relevance slider interface is changed by the user.

FIG. 14 is a flow diagram that illustrates a process for determining a plurality of domain names based on a search string and a desired relevance that may be repeated every time a new search string is entered in the search string entry field by the user and/or the desired relevance on the relevance slider interface is changed by the user.

### DETAILED DESCRIPTION

The present inventions will now be discussed in detail with regard to the attached drawing figures that were briefly described above. In the following description, numerous specific details are set forth illustrating the Applicant's best mode for practicing the invention and enabling one of ordinary skill in the art to make and use the invention. It will be obvious, however, to one skilled in the art that the present invention may be practiced without many of these specific details. In other instances, well-known machines, structures, and method steps have not been described in particular detail in order to avoid unnecessarily obscuring the present invention. Unless otherwise indicated, like parts and method steps are referred to with like reference numerals.

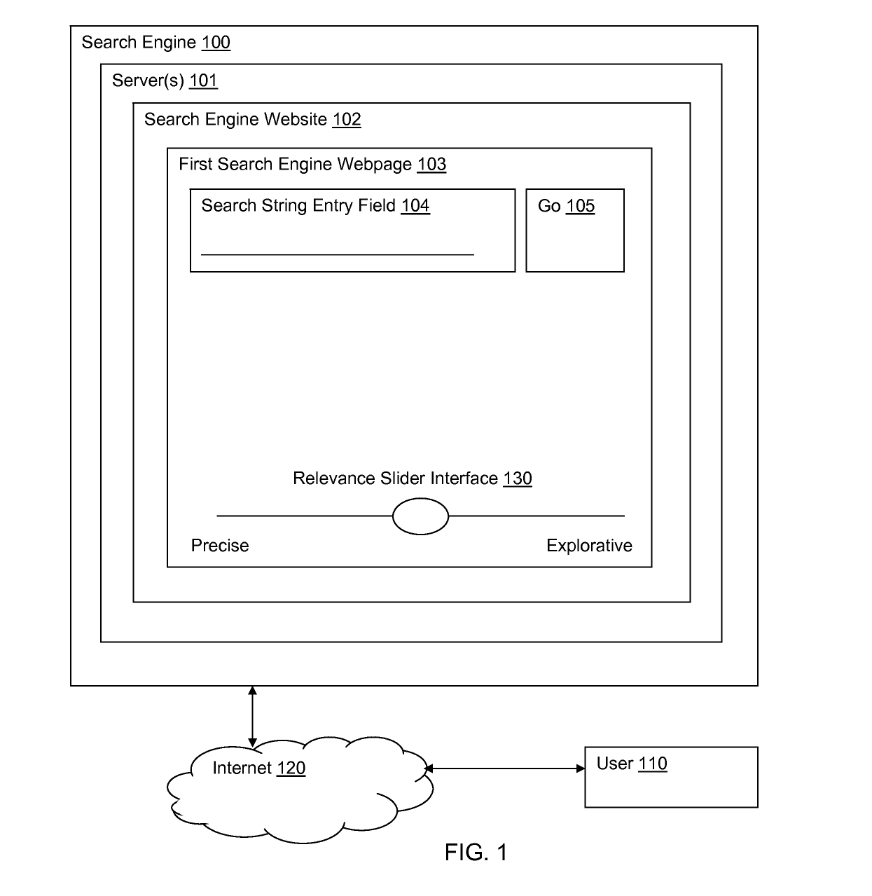

FIGS. 1-6 are block diagrams of embodiments of systems that may be used to practice the present invention. While only one user 110 is illustrated to simplify the process of describing the present invention, the invention is not so limited and in practice any number of different users 110 may exist and use the invention.

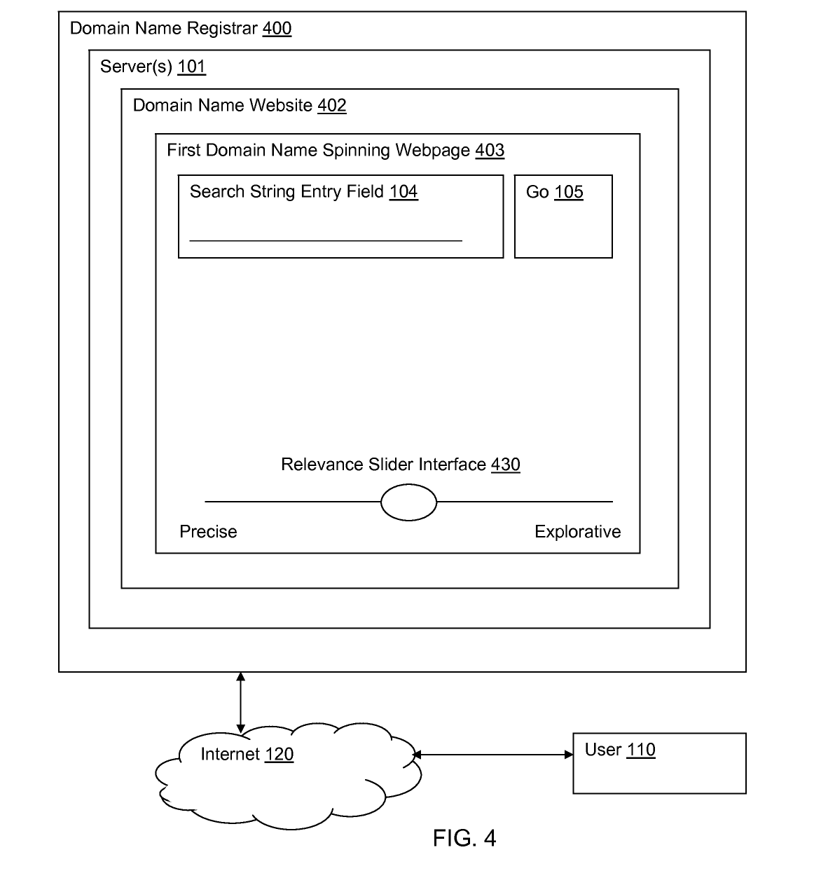

The arrows in FIGS. 1-6 represent networks that allow, as examples, the user 110 and search engine 100 (in FIGS. 1-3) and the user 110 and the domain name registrar 400 (in FIGS. 4-6) to communicate with each other, possibly via the Internet 120. A network is a collection of links and nodes (e.g., multiple computers and/or other devices connected together) arranged so that information may be passed from one part of the network to another over multiple links and through various nodes. Examples of networks include the Internet 120, the public switched telephone network, the global Telex network, computer networks (e.g., an intranet, an extranet, a local-area network, or a wide-area network), wired networks, wireless networks, cell phone networks and/or combinations thereof. The invention may be used with any known or later developed type of network.

The Internet 120 is a worldwide network of computers and networks arranged to allow for the easy and robust exchange of information between users 110 on client computers running browsers. Hundreds of millions of users 110 around the world have access to computers connected to the Internet 120 via Internet Service Providers (ISPs).

Content providers place multimedia information (e.g., text, graphics, audio, video, animation, and other forms of data) at specific locations on the Internet that may be referred to as a website. The combination of all the websites and their corresponding webpages on the Internet 120 is generally known as the World Wide Web (WWW) or simply the Web. FIGS. 1-3 illustrate a search engine website 102 which may be owned and operated by a search engine 100 while FIGS. 4-6 illustrate a domain name website 402 that may be owned and operated by a domain name registrar 400.

For search engines 100, domain name registrars 400 and users 110, the Internet 120 continues to be increasingly valuable. Users 110 use the Internet 120 for everyday tasks, from social networking, shopping, banking, and paying bills to consuming media and entertainment. Users 110 may also use search engines 100 to find search results 240, 250, 260. The search results 240, 250, 260 may be, as non-limiting examples, description of websites or active links to websites. Users 110 may also want to use domain name registrars 400 to create and register one or more available domain names 540, 550, 560.

The search engine website 102 in FIGS. 1-3 and the domain name website 402 in FIGS. 4-6 may consist of a single webpage, but typically consist of multiple interconnected and related webpages. Websites 102, 402 may reside on one or more servers 101 that may be geographically near each other or separated to assist in load balancing and shortening communication delays caused by geographic distances between websites 102, 402 and users 110. Menus, links, tabs, etc. may be used by users 110 to move between different web pages within the website 102, 402 or to move to a different website altogether.

The search engine websites 102 and domain name website 402 may be created using website code, which may comprise, as a non-limiting example, HyperText Markup Language (HTML) to generate a standard set of tags that define how the webpages 103, 403 for the websites 102, 402 are to be displayed.

Users 110 may access the search engine website 102 or domain name website 402 using software known as an Internet browser, such as MICROSOFT INTERNET EXPLORER, MOZILLA FIREFOX or GOOGLE CHROME. After the browser has located the desired website 102, 402, the browser may request and receive information from a particular webpage 103, 203, 303, 403, 503, 603 within the website 102, 402, typically in the form of an HTML document, and then display the webpage 103, 203, 303, 403, 503, 603 content for the user 110. The user 110 may then view other webpages at the same website 102, 402 or move to an entirely different website using the browser.

The search engine website 102 and domain name website 402 may be hosted or operated by one or more servers 101 which may be hosting servers. The one or more servers 101 may be, as non-limiting examples, one or more Dell PowerEdge(s) rack server(s), HP Blade Server(s), or IBM Rack or Tower server(s), although other types or combination of servers 101 may also be used. The one or more servers 101 comprise the electronic hardware necessary to run computer programs that may be written to perform various functions, processes, methods and steps of the present invention. The one or more servers 101 may be operated by one or more entities and may communicate with each other using any desired protocol. As a specific non-limiting example, the servers 101 may communicate with each other over Application Program Interfaces (APIs). This allows searches to be performed on third party search engines.

Some search engines 100 and domain name registrars 400, typically those that are larger and more sophisticated, may provide their own hardware, software, and connections to the Internet 120 to operate their own websites 102, 402. However, some search engines 100 and domain name registrars 400 either do not have the resources available or do not want to create and maintain the infrastructure necessary to host their own websites 102, 402. To assist such search engines 100 and domain name registrars 400, hosting providers exist that offer hosting services to websites 102, 402. These hosting providers typically provide the hardware, software, and electronic communication equipment necessary to connect multiple websites 102, 402 to the Internet 120. A single hosting provider may literally host thousands or millions of websites 102, 402 on one or more servers 101.

FIGS. 1-3 illustrate a search engine 100. The search engine 101 may be operated on one or more hardware servers 101. The search engine 100 may include a search engine website 102 that comprises one or more webpages 103, 203, 303. The one or more webpages 103, 203, 303 may be different webpages 103, 203, 303 or be the same webpage 103, 203, 303 that has been altered or updated.

FIGS. 4-6 illustrate a domain name registrar 400. A domain name registrar 400 may be any entity capable of registering a domain name to a user 110 and may be, as non-limiting examples, a registrar, registry or a reseller. The domain name registrar 400 may be operated on one or more hardware servers 101. The domain name registrar 400 may include a domain name website 402 that comprises one or more webpages 403, 503, 603. The one or more webpages 403, 503, 603 may be different webpages 403, 503, 603 or be the same webpage 403, 503, 603 that has been altered or updated.

FIGS. 1-6 illustrate a plurality of webpage 103, 203, 303, 403, 503, 603 that may have a search string entry field 104. The search string entry field 104 may be designed to allow the user 110 to enter a search string. The search string entered by the user 110 is preferably a plurality of characters or text, such as, as a non-limiting example, alpha-numeric characters, that comprise one or more words in one or more languages. The search string entered by the user 110 into the search string entry field 104 may be selected by the user to allow the present invention to produce and display search results 240, 250, 260 or domain names 540, 550, 560 that are relevant to the search string.

FIGS. 1-6 illustrate a plurality of webpages 103, 203, 303, 403, 503, 603 that may also have a relevance slider interface 130, 230, 330, 430, 530, 630. The relevance slider interface 130, 230, 330, 430, 530, 630 may be designed to allow the user 110 to select a desired relevance (and change the desired relevance any number of times as desired by the user 110) of the search string to the search results 240, 340, 440, 540, 640.

The relevance slider interface 130, 230, 330, 430, 530, 630 may be any webpage or Internet method now known or later developed that allows the user 110 to select or indicate a desired relevance. In a preferred embodiment, the relevance slider interface 130, 230, 330, 430, 530, 630 is a graphical interface or control that allows the user 110 to slide a graphical image (shown as a ball in FIGS. 1-6) along a scale. In other embodiments, the relevance slider interface 130, 230, 330, 430, 530, 630 may be a graphical control interface, user interface, pull-down menu, radio buttons, or any other method that would allow the search engine 100 or domain name registrar 400 to receive a desired relevance from the user 110. The relevance slider interface 130, 230, 330, 430, 530, 630 may be located anywhere on the webpage 103, 203, 303, 403, 503, 603.

The desired relevance may comprise a location on the scale provided by the relevance slider interface 130, 230, 330, 430, 530, 630. The scale may range from a high relevance to a low relevance and have any number of different intermediate values. The high desired relevance preferably indicates that the search results 240, 250, 260, 340, 350, 360 or domain names 540, 550, 560, 640, 650, 660 match very closely (as closely as possible) to the search string while a low desired relevance preferably indicates that the search results 240, 250, 260, 340, 350, 360 or domain names 540, 550, 560, 640, 650, 660 should only be indirectly related to the search string. An intermediate value for the desired relevance preferably indicates that the search results 240, 250, 260, 340, 350, 360 or domain names 540, 550, 560, 640, 650, 660 should match the search string somewhere between the high relevance and the low relevance.

High desired relevance preferably means exact word matches or words frequently used together between the search string and the search results 240, 250, 260, 340, 350, 360 or domain names 540, 550, 560, 640, 650, 660. Intermediate desired relevance preferably means synonyms or words that are sometimes used together between the search string and the search results 240, 250, 260, 340, 350, 360 or domain names 540, 550, 560, 640, 650, 660. Low desired relevance preferably means antonyms or words that are only occasionally associated together between the search string and the search results 240, 250, 260, 340, 350, 360 or domain names 540, 550, 560, 640, 650, 660. Electronic dictionaries may be used to determine synonyms and antonyms and the degree of word association may be determined by analyzing any desired corpse of words, such as the text in one or more websites. To improve the speed of the process, the degree of various word associations may be stored in a database.

The webpages 103, 203, 303, 403, 503, 603 may include a Go 105 button. The Go 105 button may be used by the user 110 to start the one or more servers 101 in determining and displaying a new search result or a new plurality of domain names based on the current search string and the current desired relevance entered and selected by the user 110. The Go 105 button may be selected at any time by the user 110 after the user 110 enters a search string and selects a desired relevance.

### Search Engine Example Embodiment

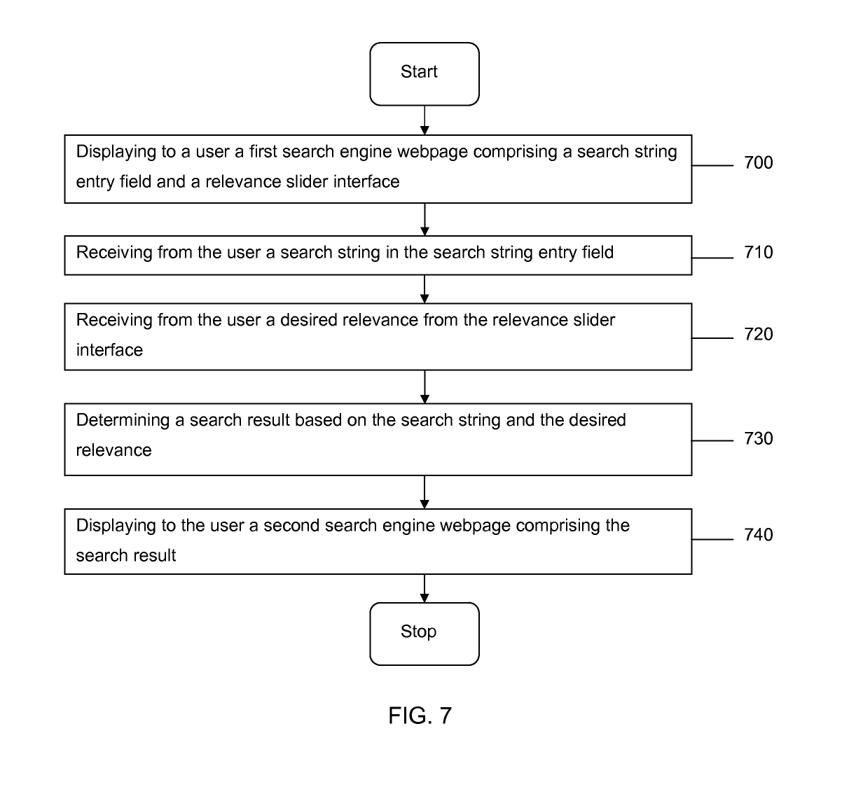

FIGS. 1 and 7 will now be used to describe one possible method of practicing the present invention. A user 110 may use a browser running on a client computer to visit a search engine website 102, where a first search engine webpage 103 may be displayed to the user 110. The first search engine webpage 103 may show a search string entry field 104 and a relevance slider interface 130 to the user 110. (Step 700)

In FIG. 1, the desired relevance is set to an intermediate position on the relevance slider interface 130, i.e., the circle on the relevance slider interface 130 is shown roughly in the middle of the scale. However, the desired relevance may initially be set at any point on the scale or at no point at all on the scale and the user 110 may either change or not change the initial position of the desired relevance on the relevance slider interface 130.

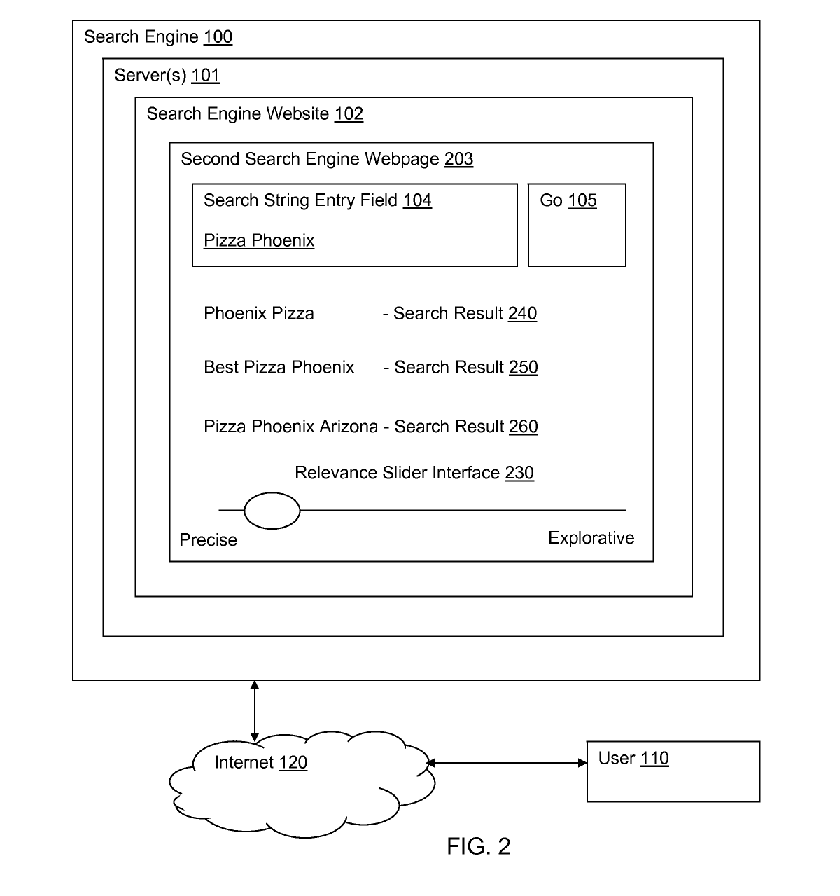

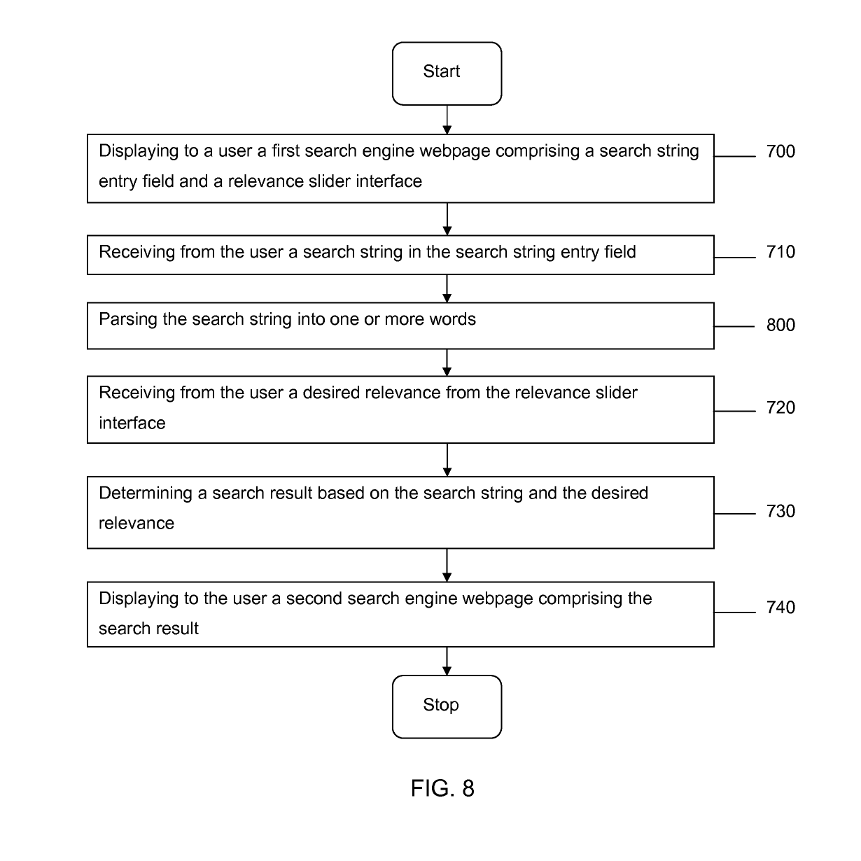

The user 110 may enter a search string into the search string entry field 104 thereby allowing the search string to be received by the search engine 100. (Step 710) As illustrated in FIG. 2, the user 110 may enter the text “Pizza Phoenix” into the search string entry field 104 thereby making “Pizza Phoenix” the search string. In a preferred embodiment, the search string may then be tokenized or broken down into the words/tokens “Pizza” and “Phoenix.” (Step 800 in FIG. 8)

The user 110 may also select a desired relevance using the relevance slider interface 130. The desired relevance is shown in an intermediate position on the relevance slider interface 130 in FIG. 1, but is shown to have been moved to a higher, more exact or precise desired relevance in FIG. 2. This may have been accomplished, as a non-limiting example, by the user 110 sliding the circle using the user's 110 mouse from the intermediate position to the precise position on the relevance slider interface 130, 230. In this manner the search engine 100 is able to receive the desired relevance of the search string with the search results 240, 250, 260 from the user 110. (Step 720)

In some embodiments, the desired relevance may comprise a location on a scale. The scale may range, as a non-limiting example, from a high relevance to a low relevance. The high relevance for the desired relevance may lead to a closely matching search result when compared to the search string while the low relevance for the desired relevance may lead to a remotely relevant or exploratory search result when compared to the search string. In other embodiments, a higher desired relevance may lead to higher results in a search result while a lower desired relevance may lead to lower results in a search result.

The search engine 100, using one or more servers 101, may determine one or more search results 240, 250, 260 based on the search string and the desired relevance. (Step 730) In some embodiments, the search string may be altered by the user's computer, preferably running an application, prior to being sent to the search engine 100. As a non-limiting example, the search string may be sent as is when a high desired relevance is selected or the search string may be altered when a lower desired relevance is selected. The altered search string may be made more fanciful or distant from the original search string the lower the selected desired relevance. The determination process may be triggered to start (thereby producing search results 240, 250, 260 or updating search results 340, 350, 360) either by the user 110 selecting the Go 105 button, the user changing the desired relevance on the relevance slide interface 130, 230, 330 and/or the user 110 entering or changing the search string in the search string entry field 104. Triggering or initiating a new search with a minimum number of keystrokes and/or actions (such as by only having to change the desired relevance by sliding the relevance slider interface 130) is particularly advantageous on mobile devices with less efficient input devices compared to desktop computers.

In the example illustrated in FIG. 2, the search string is “Pizza Phoenix” and the desired relevance selected by the user 110 is precise or highly relevant. A precise or highly relevant desired relevance indicates that the search results preferably should either exactly match, be extremely close synonyms or have highly associated words to the words in the search string. As an example, FIG. 2 illustrates a selected desired relevance of “Precise” combined with a search string of “Pizza Phoenix” that then produces search results “Phoenix Pizza” 240, “Best Pizza Phoenix” 250 and “Pizza Phoenix Arizona” 260.

While three search results 240, 250, 260 are illustrated in FIG. 2, any number of search results may be determined as desired. The search results may be used by any process that spins various word combinations. As a non-limiting example, the search results 240, 250, 260 may be links to webpages related (as modified by the desired relevance) to the search string. The search results 240, 250, 260 may be displayed on a second search engine webpage 203 to the user 110. (Step 740)

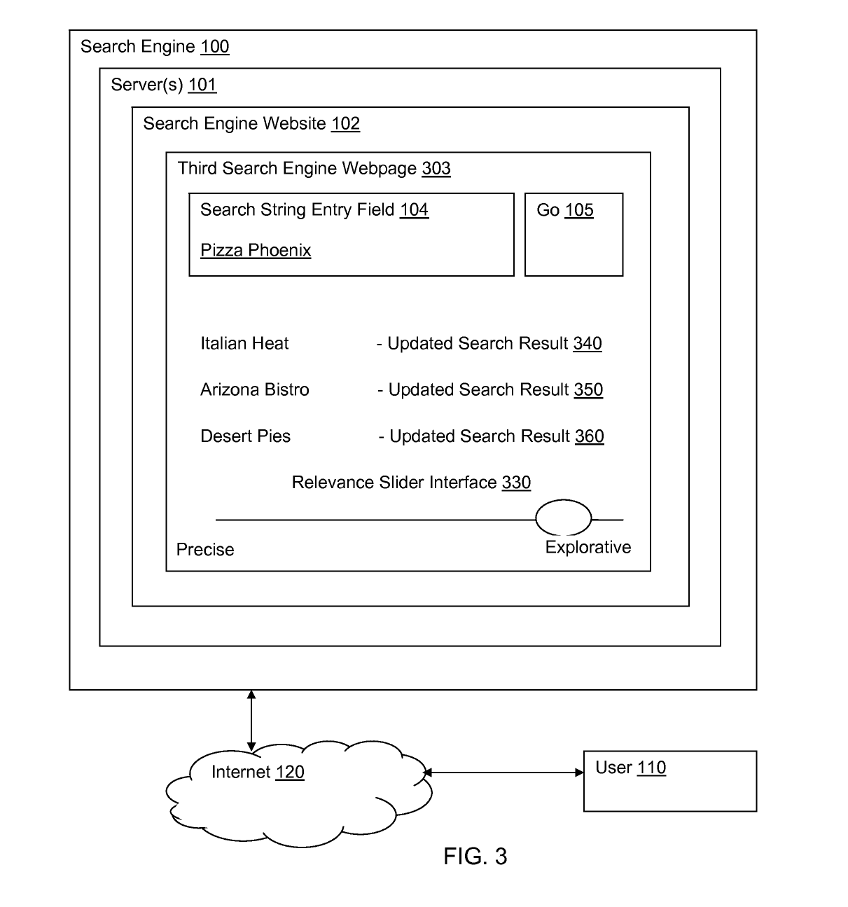

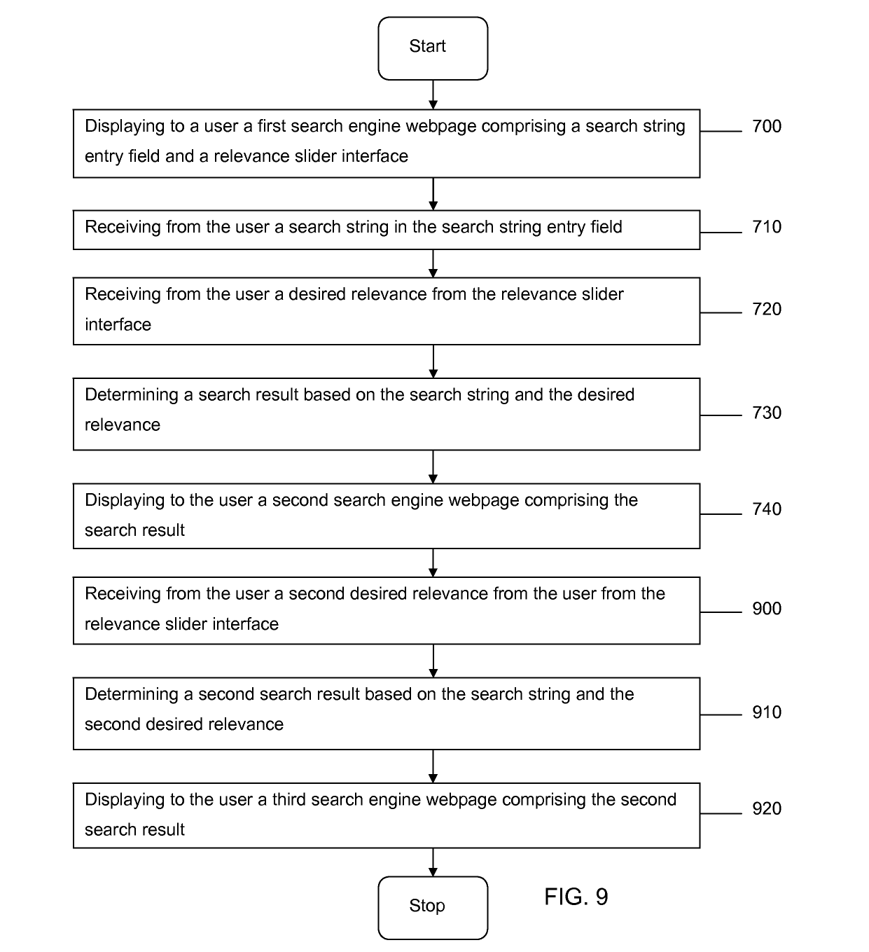

Another embodiment of the invention is illustrated in FIGS. 3 and 9. After the search results 240, 250, 260 have been displayed on the second search engine webpage 203 as discussed in the previous embodiments, the user 110 may alter the search string in the search string entry field 104 and/or alter the desired relevance on the relevance slider interface 230. The search engine 100 may detect and receive from the user 110 a second desired relevance. (Step 900)

FIG. 3 illustrates a third search engine webpage 303 with a search string of “Pizza Phoenix,” but where the desired relevance has been changed to a low relevance. As a non-limiting example, the low relevance has been labeled “Explorative” in FIGS. 1-6, however any term may be used on the relevance slider interface 330 that indicates a low desired relevance.

The search engine 100 may determine a second or updated search result 340, 350, 360 based on the current search string (“Pizza Phoenix”) and the second desired relevance (“Explorative”). As examples, “Italian Heat,” “Arizona Bistro” and “Desert Pies” may be determined by the search engine 100 (Step 910) and then displayed to the user 110 on a third search engine webpage 303 (Step 920).

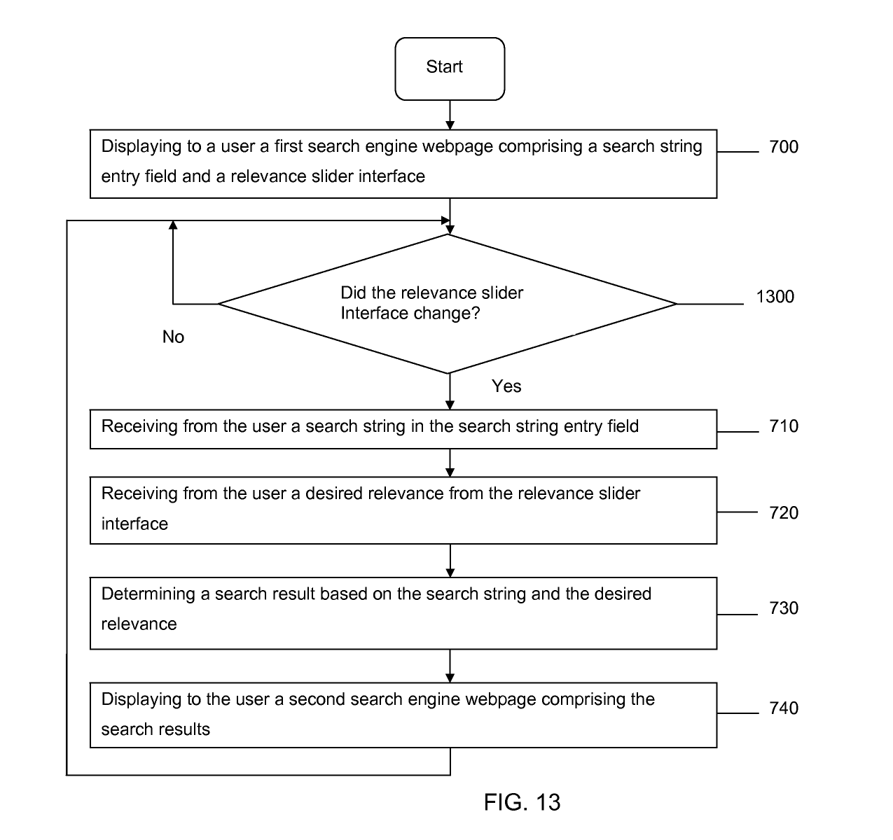

FIG. 13 illustrates another embodiment that allows the above described process to be repeated as many times as desired. In this embodiment, the search results 240, 250, 260 may be updated every time the desired relevance is altered/changed on the relevance slider interface 330. (Step 1300) The relevance slider interface 130 and/or any other methods of altering the desired relevance may be continuously or periodically monitored. When a change to the desired relevance is detected, an entirely new search may be performed using the current search string and the changed desired relevance. In this manner an entirely new search may be performed every time the desired relevance is changed by the user 110. In fact, each move of the relevance slider interface 130 may trigger a new search producing a new search result using the current search string and the changed desired relevance. In some embodiments, when a search is performed, each search result in a plurality of search results may be given a score and the plurality of search results and their corresponding scores may be transmitted to the user's 110 computer (which may be, as non-limiting examples, a mobile device or a desktop computer). The user's 100 computer may run an application to facilitate this process. The user's 110 computer may select one or more of the search results in the plurality of search results to display to the user 110 based on the desired relevance. A higher desired relevance may cause search results with a higher score to be displayed to the user 110 while a lower desired relevance may cause search results with a lower score to be displayed to the user 110. In some embodiments, sliding the relevance slider interface 130 up or down allows the user's 100 computer to display search results having higher or lower scores respectively. If the desired relevance is changed to a value previously selected by the user 110, the updated search results 350, 350, 360 may be either the same as previously displayed for that duplicate desired relevance or, in some embodiments, entirely new updated search results may be displayed to the user 110.

### Domain Name Registrar Example Embodiment

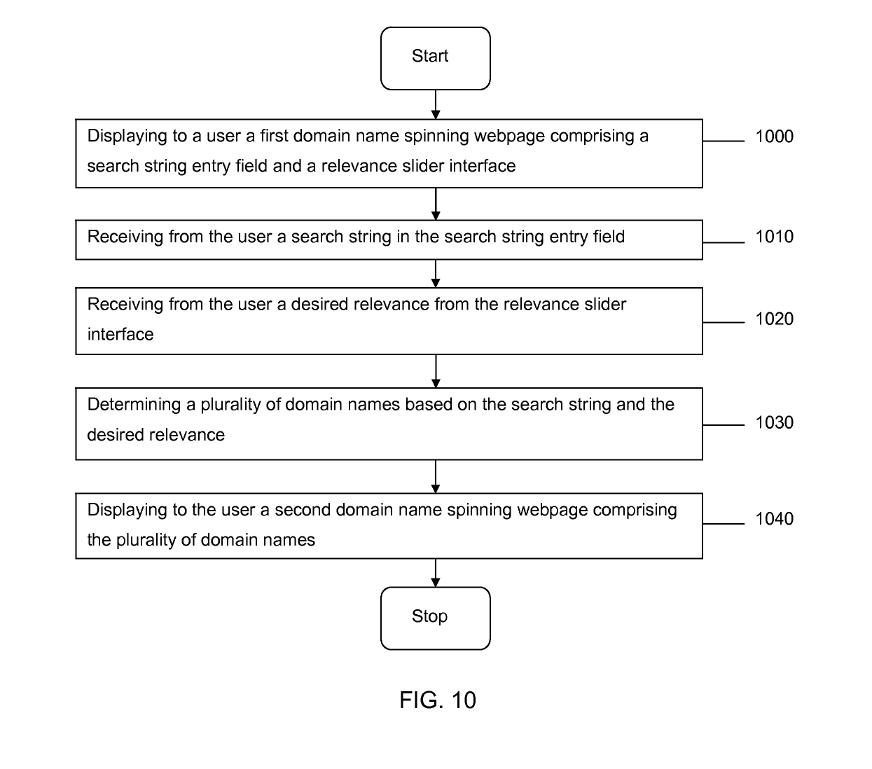

FIGS. 4 and 10 will now be used to describe possible methods of practicing the present invention. A user 110 may use a browser running on a client computer to visit a domain name website 402, where a first domain name spinning webpage 403 may be displayed to the user 110. The first domain name spinning webpage 403 may show a search string entry field 104 and a relevance slider interface 130 to the user 110. (Step 1000)

In FIG. 4, the desired relevance is set to an intermediate position on the relevance slider interface 430, i.e., the circle on the relevance slider interface 430 is shown roughly in the middle of the scale. However, the desired relevance may initially be set at any point on the scale or at no point at all on the scale and the user 110 may either change or not change the initial position of the desired relevance on the relevance slider interface 430.

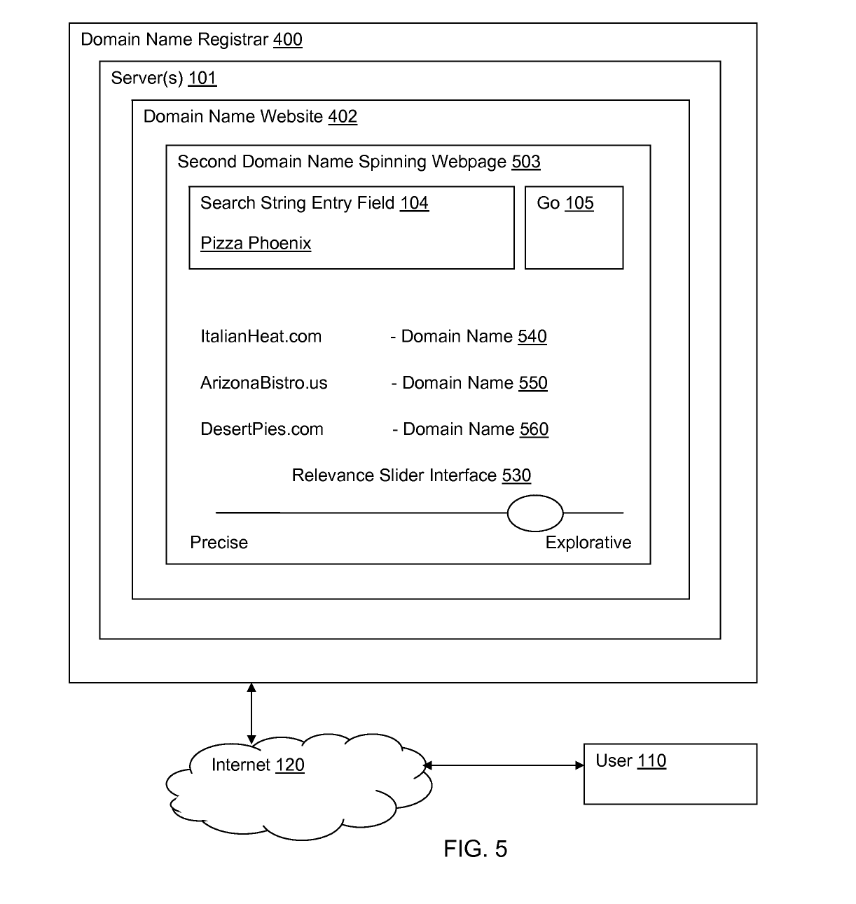

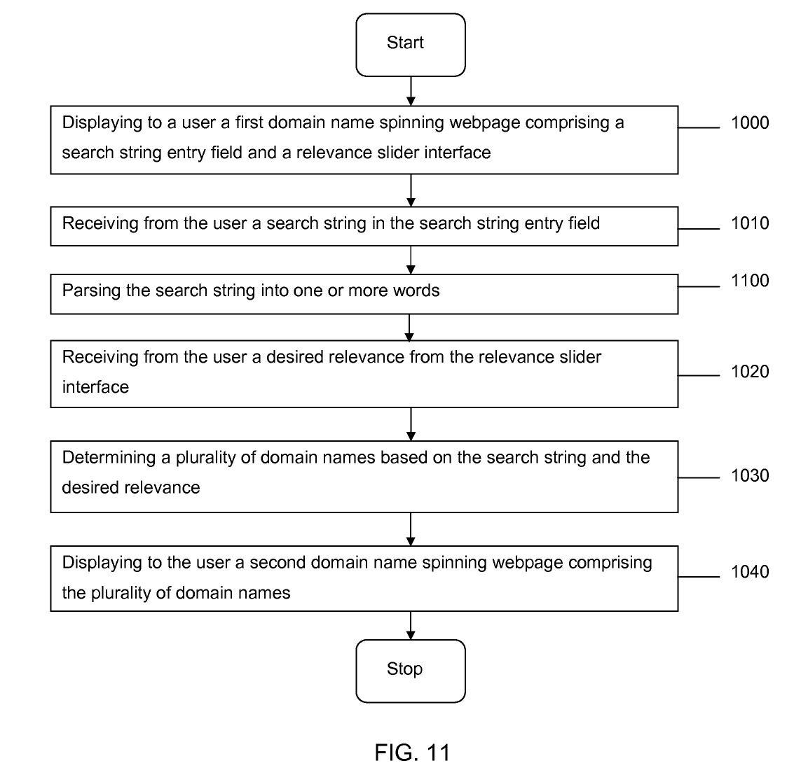

The user 110 may enter a search string into the search string entry field 104 thereby allowing the search string to be received by the domain name registrar 400. (Step 1010) As illustrated in FIG. 5, the user 110 may enter the text “Pizza Phoenix” into the search string entry field 104 thereby making “Pizza Phoenix” the search string. In a preferred embodiment, the search string may then be tokenized or broken down into the words/tokens “Pizza” and “Phoenix.” (Step 1100 in FIG. 11)

The user 110 may also select a desired relevance using the relevance slider interface 430. The desired relevance is shown in an intermediate position on the relevance slider interface 430 in FIG. 4, but is shown to have been moved to a low desired relevance in FIG. 5. This may have been accomplished, as a non-limiting example, by the user 110 sliding the circle using the user's mouse from the intermediate position to the “Explorative” position on the relevance slider interface 430, 530. In this manner the domain name registrar 400 is able to receive the desired relevance from the user 110. (Step 1020)

In some embodiments, the desired relevance may comprise a location on a scale. The scale may range, as an example, from a high relevance to a low relevance. The high relevance for the desired relevance may lead to a plurality of closely matching domain names when compared to the search string while the low relevance for the desired relevance may lead to a remotely relevant or an exploratory plurality of domain names when compared to the search string. In other embodiments, a high desired relevance may lead to the top results in a search while a lower desired relevance may lead to lower results in the search.

The domain name registrar 400, using one or more servers 101, may determine one or more domain names 540, 550, 560 based on the search string and the desired relevance. (Step 1030) In some embodiments, the search string may be altered by the user's computer, possibly by an application, prior to being sent to the search engine 100. As a non-limiting example, the search string may be sent as is when a high desired relevance is selected or the search string may be altered when a lower desired relevance is selected. The altered search string may be made more fanciful or distant from the original search string the lower the selected desired relevance. The determination process may be triggered to start (thereby producing search results 540, 550, 560 or updating search results 640, 650, 660) either by the user 110 selecting the

Go 105 button, the user changing the desired relevance on the relevance slide interface 430, 530, 630 and/or the user 110 entering or changing the search string in the search string entry field 104. Triggering or initiating a new search with a minimum number of keystrokes and/or actions (such as by only having to change the desired relevance by sliding the relevance slider interface 130) is particularly advantageous on mobile devices with less efficient input devices compared to desktop computers.

In the example illustrated in FIG. 5, the search string is “Pizza Phoenix” and the desired relevance selected by the user 120 is “Explorative” meaning a low desired relevance. A low desired relevance indicates that the determined domain names 540, 550, 560 should preferably only indirectly relate, be distant synonyms, be only distantly associated or even be antonyms to the words in the search string. As an example, FIG. 5 illustrates a selected desired relevance of “Explorative” combined with a search string of “Pizza Phoenix” that then produces domain names of “ItalianHeat.com” 540, “ArizonaBistsro.us” 550 and “DesertPies.com” 560.

While three domain names 540, 550, 560 are illustrated in FIG. 5, any number of domain names may be determined as desired by the domain name registrar 400. In some embodiments, the determined domain names are checked for availability and only available domain names are displayed to the user 110. The domain names may be used by any process that uses various domain name combinations. The (available) domain names 540, 550, 560 may be displayed on a second domain name spinning webpage 203 to the user 110. (Step 1040)

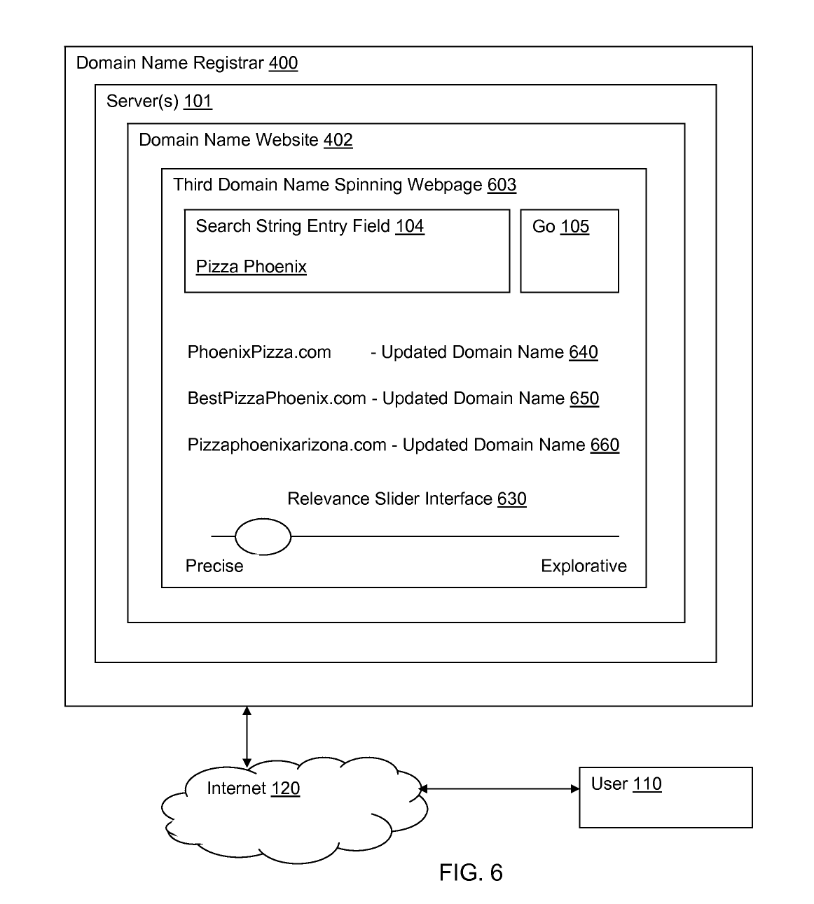

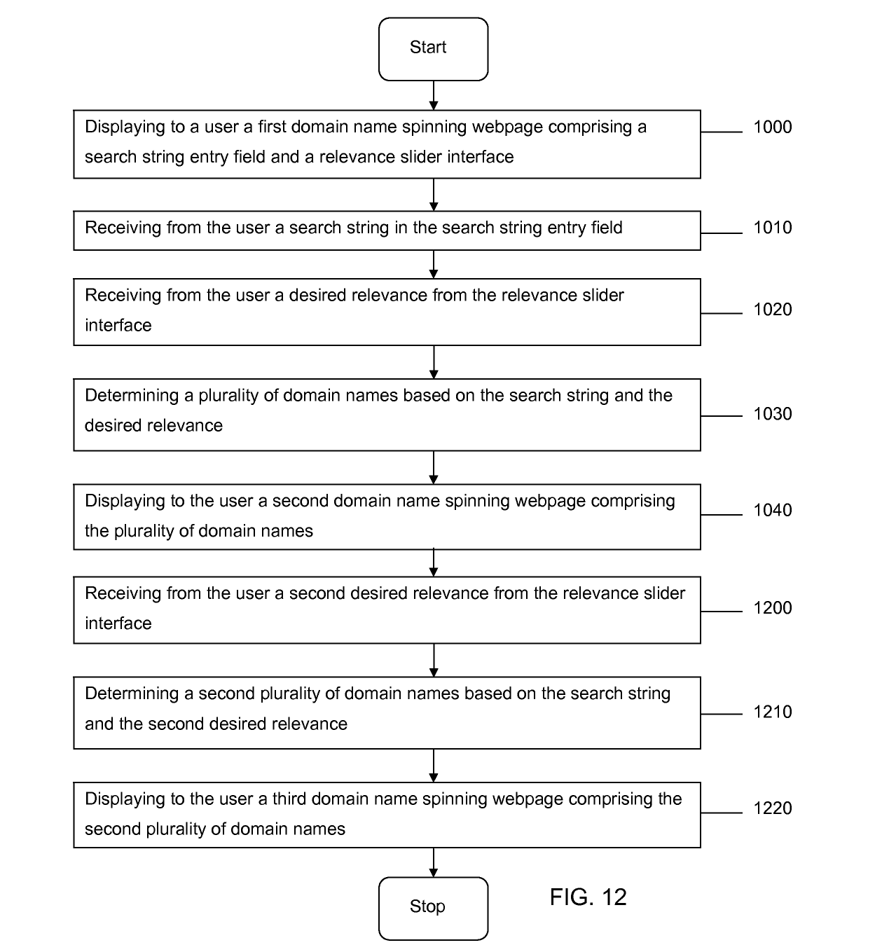

Another embodiment of the invention is illustrated in FIGS. 6 and 12. After the domain names 540, 550, 560 have been displayed on the second domain name spinning webpage 503 as previously discussed, the user 110 may alter the search string in the search string entry field 104 and/or alter the desired relevance using the relevance slider interface 630. The search engine 100 may detect and receive from the user 110 a second desired relevance. (Step 1200)

FIG. 6 illustrates a third domain name spinning webpage 603 with a search string of “Pizza Phoenix,” but where the desired relevance has been changed to a high desired relevance. As a non-limiting example, the high desired relevance has been labeled “Precise” in FIGS. 1-6, however any term may be used on the relevance slider interface 330 that indicates a high desired relevance.

The domain name registrar 400 may determine a second or updated plurality of domain names 640, 650, 660 based on the current search string (“Pizza Phoenix”) and the second desired relevance (“Precise”). (Step 910) As examples, “PhoenixPizza.com,” “BestPizzaPhoenix.com” and “PizzaPhoenixArizona.com” have been determined by the domain name registrar 400 (Step 1210) and then displayed to the user 110 on a third domain name spinning webpage 603 (Step 1220).

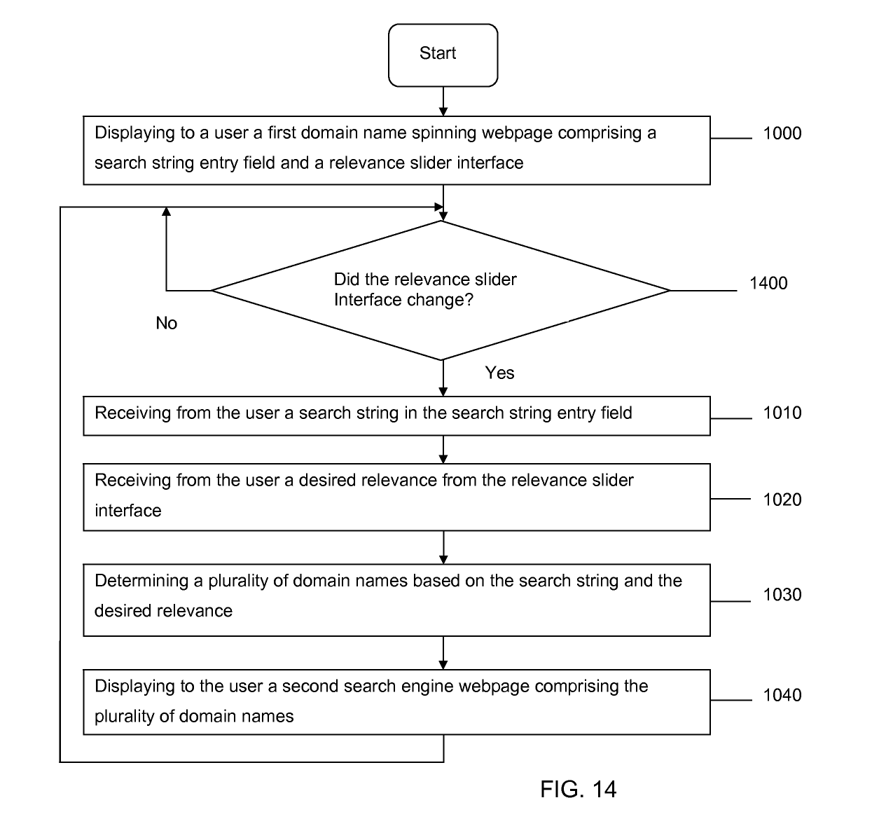

FIG. 14 illustrates another embodiment that allows the above described process to be repeated as many times as desired. In this embodiment, the domain names 540, 550, 560 and updated domain names 640, 650, 660 may be updated every time the desired relevance is altered/changed on the relevance slider interface 530, 630 by the user 110. (Step 1400) The relevance slider interface 130 and/or any other methods of altering the desired relevance may be continuously or periodically monitored. When a change to the desired relevance is detected, an entirely new search may be performed using the current search string and the changed desired relevance. In this manner an entirely new search may be performed every time the desired relevance is changed by the user 110. In fact, each move of the relevance slider interface 130 may trigger a new search producing a new search result using the current search string and the changed desired relevance. In some embodiments, when a search is performed, each search result in a plurality of search results may be given a score and the plurality of search results and their corresponding scores may be transmitted to the user's 110 computer (which may be, as non-limiting examples, a mobile device or a desktop computer). The user's 100 computer may run an application to facilitate this process. The user's 110 computer may select one or more of the search results in the plurality of search results to display to the user 110 based on the desired relevance. A higher desired relevance may cause search results with a higher score to be displayed to the user 110 while a lower desired relevance may cause search results with a lower score to be displayed to the user 110. In some embodiments, sliding the relevance slider interface 130 up or down allows the user's 100 computer to display search results having higher or lower scores respectively. If the desired relevance is changed to a value previously selected by the user 110, the updated domain names 640, 650, 660 may be either the same as previously displayed for the duplicated desired relevance or, in some embodiments, entirely new updated search results may be displayed to the user 110 on the third domain name spinning webpage 603.

Other embodiments and uses of the above inventions will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and in no way intended for defining, determining, or limiting the present invention or any of its embodiments.

The invention claimed is:

1. A method, comprising the steps of:
a) displaying, using one or more servers, to a user a first search engine webpage comprising a search string entry field and a relevance slider interface;
b) receiving, using the one or more servers, from the user a search string in the search string entry field;
c) receiving, using the one or more servers, from the user a desired relevance from the relevance slider interface;
d) determining, using the one or more servers, a search result based on the search string and the desired relevance; and
e) displaying, using the one or more servers, to the user a second search engine webpage comprising the search result.

2. The method of claim 1, further comprising the step of:
f) parsing, using the one or more serves, the search string into one or more words.

3. The method of claim 1, wherein the desired relevance comprises a location on a scale, wherein the scale ranges from a high relevance to a low relevance and wherein the high relevance for the desired relevance leads to a closely matching search result when compared to the search string while the low relevance for the desired relevance leads to a remotely relevant search result when compared to the search string.

4. The method of claim 1, further comprising the step of:
f) receiving, using the one or more servers, from the user a second desired relevance from the relevance slider interface;
g) determining, using the one or more servers, a second search result based on the search string and the second desired relevance; and
h) displaying, using the one or more servers, to the user a third search engine webpage comprising the second search result.

5. The method of claim 1, wherein the relevance slider interface comprises a high relevance location and a low relevance location.

6. A method, comprising the steps of:
a) displaying, using one or more servers, to a user a first domain name spinning webpage comprising a search string entry field and a relevance slider interface;
b) receiving, using the one or more servers, from the user a search string in the search string entry field;
c) receiving, using the one or more servers, from the user a desired relevance from the relevance slider interface;
d) determining, using the one or more servers, a plurality of domain names based on the search string and the desired relevance; and
e) displaying, using the one or more servers, to the user a second domain name spinning webpage comprising the plurality of domain names.

7. The method of claim 6, further comprising the step of:
f) parsing, using the one or more serves, the search string into one or more words.

8. The method of claim 6, wherein the desired relevance comprises a location on a scale, wherein the scale ranges from a high relevance to a low relevance and wherein the high relevance for the desired relevance leads to a closely matching plurality of domain names when compared to the search string while the low relevance for the desired relevance leads to a remotely relevant plurality of domain names when compared to the search string.

9. The method of claim 6, further comprising the step of:
f) receiving, using the one or more servers, from the user a second desired relevance from the relevance slider interface;
g) determining, using the one or more servers, a second plurality of domain names based on the search string and the second desired relevance; and
h) displaying, using the one or more servers, to the user a third domain name spinning webpage comprising the second plurality of domain names.

10. The method of claim 6, wherein each domain name in the plurality of domain names is available for registration.

11. The method of claim 6, wherein the relevance slider interface comprises a high relevance location and a low relevance location.

12. A method, comprising the steps of:
a) displaying, using one or more servers, to a user a first search engine webpage comprising a search string entry field and a relevance slider interface;
b) receiving, using the one or more servers, a search string in the search string entry field; and
c) performing, using the one or more servers, the following steps every time the relevance slider interface is changed by the user:
i) receiving, using the one or more servers, from the user a desired relevance from the relevance slider interface;
ii) determining, using the one or more servers, a search result based on the search string and the desired relevance; and
iii) displaying, using the one or more servers, to the user a second search engine webpage comprising the search results.

13. The method of claim 12, further comprising the step of:
c) parsing, using the one or more serves, the search string into one or more words.

14. The method of claim 12, wherein the desired relevance comprises a location on a scale, wherein the scale ranges from a high relevance to a low relevance and wherein the high relevance for the desired relevance leads to a closely matching search result when compared to the search string while the low relevance for the desired relevance leads to a remotely relevant search result when compared to the search string.

15. The method of claim 12, wherein the relevance slider interface comprises a high relevance location and a low relevance location.

16. A method, comprising the steps of:
a) displaying, using one or more servers, to a user a first domain name spinning webpage comprising a search string entry field and a relevance slider interface;
b) receiving, using the one or more servers, a search string in the search string entry field; and
c) performing, using the one or more servers, the following steps every time the relevance slider interface is changed by the user:
i) receiving, using the one or more servers, from the user a desired relevance from the relevance slider interface;
ii) determining, using the one or more servers, one or more domain names based on the search string and the desired relevance; and
iii) displaying, using the one or more servers, to the user a second domain name spinning webpage comprising the one or more domain names.

17. The method of claim 16, further comprising the step of:
c) parsing, using the one or more serves, the search string into one or more words.

18. The method of claim 16, wherein the desired relevance comprises a location on a scale, wherein the scale ranges from a high relevance to a low relevance and wherein the high relevance for the desired relevance leads to a closely matching plurality of domain names when compared to the search string while the low relevance for the desired relevance leads to a remotely relevant plurality of domain names when compared to the search string.

19. The method of claim 16, wherein each domain name in the plurality of domain names is available for registration.

20. The method of claim 16, wherein the relevance slider interface comprises a high relevance location and a low relevance location.
